(19) United States
(12) Patent Application Publication
(10) Pub. No.: US 2025/0219569 A1
(43) Pub. Date: Jul. 3, 2025

(54) HYBRID SYSTEM COMPRISING A WIND TURBINE AND AIR DEFLECTORS WITH SOLAR PANELS

(71) Applicant: Nikolaos VROUSIS, Athens (GR)

(72) Inventor: Nikolaos VROUSIS, Athens (GR)

(21) Appl. No.: 18/852,269

(22) PCT Filed: May 4, 2023
(86) PCT No.: PCT/GR2023/000017

§ 371 Date: Sep. 27, 2024

(30) Foreign Application Priority Data
May 10, 2022 (GR) 20220100379

(51) Int. Cl. H02S 10/12; F03D 3/04

(52) U.S. Cl. CPC H02S 10/12; F03D 3/0418; F03D 3/0427; F05B 2220/708; F05B 2240/13

(57) ABSTRACT

A) Wind turbine-solar panel hybrid system. The solar panels are attached to the wind turbine in such a way that they deflect the wind and direct it towards the wind turbine. The solar panels also serve to generate electricity (FIG. 1 1.2.3.φ). B) The wind turbine uses separating panels of different materials that are properly adjusted and deflect the wind towards the wind turbine resulting in multiple efficiency (FIG. 1 1.2.3.φ).

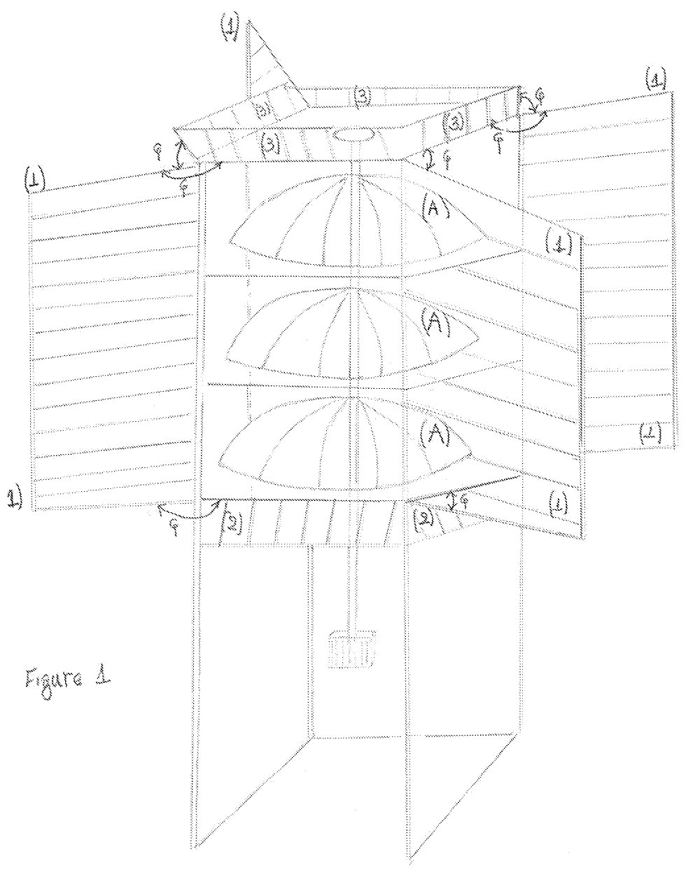

The hybrid system of wind turbine and solar panel (FIG. 1) consists of a wind turbine (FIG. 1A), in this case with a vertical axis, to which 4 separating solar panels have been adapted in a way that form an angle (φ) with its four sides (FIG. 1 1). (Solar panels can be double-sided, i.e. panels adapted to touch each other with the surface not exposed to the sun) and deflect the wind in the direction of the wind turbine. Additional solar panels can be fitted to the top and bottom of the wind turbine which will form an angle with the support sides. (FIGS. 1 2,3,φ).

The angle (φ) formed by the panels with the surface of the wind turbine to which they are attached is such that it deflects the air impinging on them towards the wind turbine (FIG. 1). The dimensions of the panels depend on the available surface, the volume of air we wish to divert towards the wind turbine and their maximum possible exposure to the sun's rays. The same criteria apply to the angle (φ) formed by the panels between them and the wind turbine.

They can be fixed, non-contacting or tangential to the wind turbine as well as mechanical that change positions depending on the position of the sun and the direction of the wind. The deflection of the wind by the panels acting as partition curtains increase the efficiency of the wind turbine by a factor that depends on their surface area and the angle (φ) they form with the tangential side of the wind turbine. Essentially, they increase the incident surface of the wind turbine and multiply its efficiency. Thus, areas of our planet that have a small annual average wind speed and cannot use wind turbines, in this way have the possibility of becoming a site for installing wind turbines. The installation of the panels becomes more economical because they are adapted to ready-made supports of the wind turbine, they can use common electrical devices either to store the generated current or to supply it to the grid. Also, the infrastructure configuration will be common, such as roads, terrain adaptation, guarding, grid connection, etc., which leads to lower operating costs of this hybrid system which makes it more competitive. Also, an important element is that space is saved which is the most valuable thing our planet has and can be used for other uses. In addition, both systems do not operate under the same conditions but complement each other. Thus, when there is cloudiness and bad weather, the solar panels do not work, but the wind turbine does. And on the contrary, when there is sunshine and apnea the solar panel works and maybe the wind turbine doesn't work.

1. The Hybrid system comprising a wind turbine and air deflectors with solar Panels consists of a wind turbine, bifacial solar panels and simple panels that are fitted around the wind turbine in such a way to deflect the wind towards the wind turbine, whether they are tangent to its structural support or not.
They are laterally adjusted to both the upper and lower base.
We use one pair of double sided (bifacial) solar panels and another pair of simple panels made from transparent material (FIG. 1, 1, 2, 3, 4 φ)
The use of the two solar panels side by side in the east west orientation provides their maximum exposure to the sun rays, while simple panels are used in the other two positions
The angle (φ) they form with the wind turbine, the dimensions, their number and the geometric shape depends on the volume of wind we wish to deflect towards the wind turbine as well as the greatest possible exposure to the sun rays for the solar panels (FIG. 1 1, 2, 3, 4 φ)
The use of changing position systems only for the solar panels and the low cost of the material we use for simple panels is an advantage for having low cost Production for the whole system.
